(19) United States
(12) Patent Application Publication
(10) Pub. No.: US 2003/0231609 A1
(43) Pub. Date: Dec. 18, 2003

(54) Local area network

(76) Inventor: Wassim Haddad, Verdun Municipality (CA)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/426,036

(22) Filed: Apr. 30, 2003

(30) Foreign Application Priority Data
Apr. 30, 2002 (GB) 0209927.3

(51) Int. Cl. H04Q 7/24

(52) U.S. Cl. 370/338; 370/395.5

(57) ABSTRACT

A local area network comprises a plurality of access points. Each access point includes a first transceiver for wireless communication with one or more user workstations. The access points include second transceivers for wireless communication with one another. At least one of the access points is configured for movement to enable re-configuration of the local area network.

### FIELD OF INVENTION

This invention relates to a local area network (LAN), that is to say a high bandwidth computer network operating over a relatively small area, such as an office or group of offices.

### BACKGROUND TO THE INVENTION

Typically, a LAN includes a plurality of access points hardwired together, the access points being positioned at appropriate positions in a building or group of offices. Each access point may act as a base station for wireless communication with a number of users of the LAN. For example, as shown in FIG. 1, one floor, indicated generally by the reference numeral 1, of a building could be provided with nine access points 2a to 2i, the access points being interconnected by hardwiring 3. Each of the access points 2a to 2i communicates with user workstations (not shown) using the Internet protocol.

The disadvantage of this type of LAN is that it is difficult to reconfigure to accommodate movement of users from one part of the floor to another, particularly where high-usage access points exist. Thus, if the access point 2d is fully utilised, and a user moves into the vicinity of that access point (either from one of the other access points or as a new user), the LAN will not be able to accommodate such a user. In this connection, it will be appreciated that, although in theory such a new user could be accommodated, in that communication with the access points would be possible, in practice communication for that user (and all other users of that access point) would become intolerably slow. In such a case, it would be necessary to provide an additional access point, and to hardwire this additional access point into the existing hardwired network.

### SUMMARY OF THE INVENTION

The present invention provides a LAN comprising a plurality of access points, each access point being provided with a first transceiver for wireless communication with one or more user workstations, wherein the access points are provided with second transceivers for wireless communication with one another, and wherein at least one of the access points is configured for movement to enable reconfiguration of the LAN.

In preferred embodiments, each of the access points will be configured for movement.

In a preferred embodiment, each access point configured for movement is provided with propulsion means for moving that access point to enable reconfiguration of the LAN.

Advantageously, each access point configured for movement is provided with a buoyancy device, the buoyancy devices being such that, in use, the access points can be positioned so as to float at predetermined heights. A respective helium balloon may constitute each of the buoyancy devices. Preferably, each of the helium balloons is such that its buoyancy substantially matches the combined mass of the associated access point and propulsion means.

Preferably, a respective electric motor and propeller constitute the propulsion means of each access point configured for movement.

Alternatively, the LAN may further comprise a tracking along which the access points can be propelled. Each access point configured for movement may be provided with a support wheel engageable with the tracking.

In a preferred embodiment each first transceiver is arranged to communicate with the or each associated user workstation using the Internet protocol. Preferably, the second transceivers are arranged to communicate with each other using the IEEE 802.11b, the IEEE 802.11a, or the HiperLAN/2 protocol.

In a further aspect, the invention provides an access point for a local area network comprising a first transceiver for wireless communication with one or more user workstations, a second transceiver for wireless communication with other access points, wherein the access points is configured for movement to enable reconfiguration of the local area network.

### BRIEF DESCRIPTION OF THE DRAWINGS

The invention will now be described in greater detail, by way of example, with reference to the drawings, in which:

FIG. 1, as previously described, is a schematic view of a known form of LAN

FIG. 2 is a schematic view of a LAN constructed in accordance with the invention;

FIG. 3 is a schematic view of one of the access points of the LAN of FIG. 2;

FIG. 4 is a schematic representation of two access points of a modified form of LAN constructed in accordance with the invention;

FIG. 5 is a schematic representation of another modified form of LAN constructed in accordance with the invention; and

FIG. 6 is a schematic view of one of the access points of the LAN of FIG. 5.

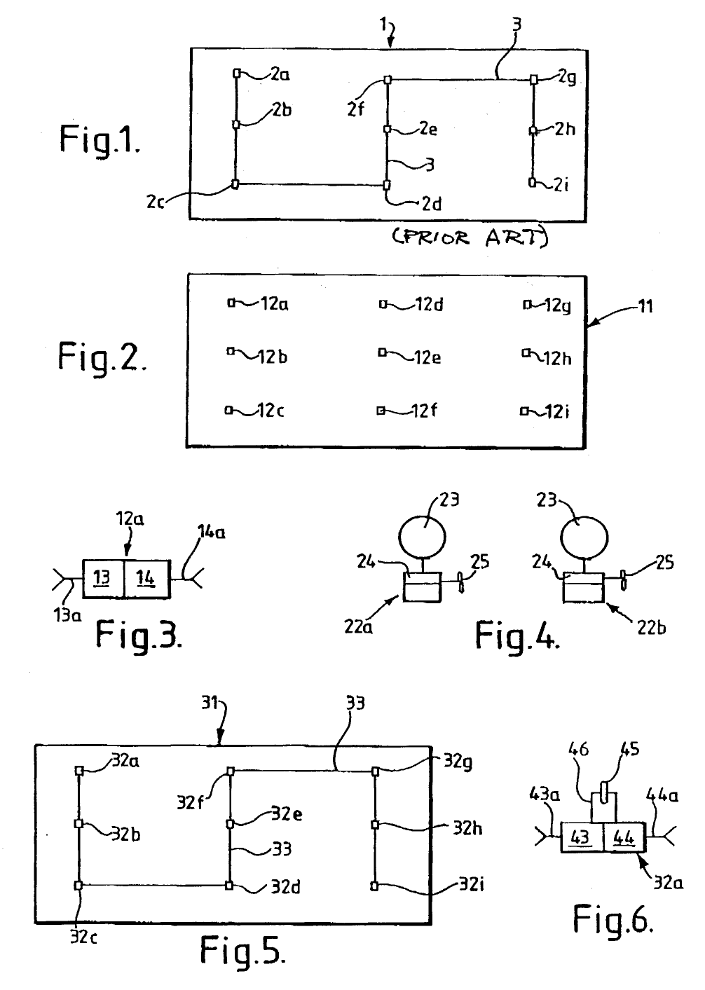

### DESCRIPTION OF PREFERRED EMBODIMENTS

Referring to the drawings, FIG. 2 is a drawing of one floor, indicated generally by the reference numeral 11, of a building provided with a LAN having nine access points 12a to 12i. As shown in FIG. 3, the access point 12a includes a first and second transceivers 13 and 14, respective antennas 13a and 14a associated therewith, and controller 15. The remaining access points 12b to 12i are of similar construction. Each of the transceivers 13 is configured to use the Internet protocol, and each of the transceivers 14 is configured to use the IEEE802.11b protocol (which operates at 2.4 to 2.4835 GHz).

Each of the access points 12a to 12i communicates with one or more user workstations (not shown) in the vicinity thereof using its first transceiver 13. The access points 12a to 12i communicate with one another using their second transceivers 14.

It will be apparent that the LAN described above is considerably easier to reconfigure than the known LAN. Thus, as the access points 12a to 12i are not hardwired together, they can be moved around the floor of the building to accommodate different user configurations. Thus, if a group of users moves from one part of the floor served by a first access point to the vicinity of another access point which is already fully utilised, the first access point could be moved with the users, thereby maintaining good utilisation. Alternatively, an additional access point (not shown) could be installed to accommodate the new users. In either case, the reconfiguration is relatively simple, as there is no hardwiring to modify.

FIG. 4 includes two access points 22a and 22b of a modified form of the LAN of FIG. 2. Each of the access points 22a and 22b is attached to a respective helium balloon 23, so that the access points can float in the air. Each access point 22a and 22b is also provided with a small electric motor 24 which can be used to power an associated propeller 25. The buoyancy of each of the helium balloons 23 is such that it just matches the combined masses of the associated access point 22a, 22b and the associated motor 24 and propeller 25. The access points 22a and 22b can, therefore, be positioned, for example, in the ceiling region of an open plan office for communication with respective groups of users.

The access points 22a and 22b are, apart from the provision of the balloons 23, motors 24 and propellers 25, identical to the access points 12a to 12i of the embodiment of FIG. 2, and so interact with one another and with the user groups in a similar manner. This embodiment has, however, an additional advantage in that an access point can more easily be moved from place to place. Control of the movement of the access points can be carried out from a central control station (not shown) under software control.

As an alternative to moving the access points using electric motors and propellers, they could be provided, instead, with air jets. It would also be possible to mount the access points on tracking provided within the ceiling region of a building. Thus, as shown in FIG. 5, a modified form of the LAN of FIG. 2 is provided in a floor, indicated generally by the reference numeral 31, of a building. The LAN has nine access points 32a to 32i, each of which is moveable along a tracking 33 provided in the ceiling region of the floor 21. As shown in FIG. 6, the access point 32a includes first and second transceivers 43 and 44, and respective antennas 43a and 44a associated therewith. The access point 32a is provided with a support wheel 45 which is rotatably mounted on a support structure 46. The wheel 45 is engageable with the track 33 to enable the access point 32a to be moved therealong. The access point 32a can be moved either by hand, or by any suitable form of propulsion means such as those described above with reference to the access points 22a to 22i. The remaining access points 32b to 32i are similar construction. As with the embodiment of FIG. 2, each of the transceivers 43 is configured to use the Internet protocol, and each of the transceivers 44 is configured to use the IEE802.11B protocol.

It will be apparent that any LAN of FIG. 5 has similar advantages to the LAN of FIG. 2, in that it is considerably easier to reconfigure the known LANs. Thus, as the access points 32a to 32i are not hardwired together, they can be moved along the tracking 33 to accommodate different user configurations. It would also be possible to install one or more additional access points to accommodate new users. In either case, the reconfiguration is relatively simply, as there is no hardwiring to modify. It will also be appreciated, however, that in some cases it may be desirable to have a LAN in which some of the access points are fixed and some are movable—this may be desirable, for example, where a part of the demand is expected to remain fixed for a long period of time.

I claim:

1. A local area network comprising a plurality of access points, each access point being provided with a first transceiver for wireless communication with one or more user workstations, wherein the access points include second transceivers for wireless communication with one another, and wherein the access points are configured for movement to enable reconfiguration of the local area network.

2. A local area network as claimed in claim 1, wherein each access point configured for movement includes a drive for moving that access point to enable reconfiguration of the local area network.

3. A local area network as claimed in claim 2, wherein each access point configured for movement includes a buoyancy device, the buoyancy devices being such that, in use, the access points can be positioned so as to float at predetermined heights.

4. A local area network as claimed in claim 3, wherein each of the buoyancy devices includes a helium balloon.

5. A local area network as claimed in claim 4, wherein each of the helium balloons is such that its buoyancy substantially matches the combined mass of the associated access point and drive.

6. A local area network as claimed in claim 2, wherein a respective electric motor and propeller comprise the drive of each access point configured for movement.

7. A local area network as claimed in claim 1, further comprising a track arrangement along which the access points configured for movement can be moved.

8. A local area network as claimed in claim 7, wherein each access point configured for movement includes a support wheel engageable with the track arrangement.

9. A local area network as claimed in claim 1, wherein each first transceiver is arranged to communicate with the or each associated user workstation using Internet protocol.

10. A local area network as claimed in claim 1, wherein the second transceivers are arranged to communicate with each other using the IEEE 802.11b, the IEEE802.11a, or the HiperLAN/2 protocol.

11. A local area network as claimed in claim 1, wherein each of the access points is configured for movement.

12. A local area network comprising a plurality of access points, each access point including a first transceiver for wireless communication with one or more user workstations, and the access points include second transceivers for wireless communication with one another, wherein the access points are configured for movement to enable reconfiguration of the local area network, and wherein each access point includes a buoyancy device, the buoyancy devices being such that, in use, the access points can be positioned to float at predetermined heights.

13. A local area network comprising a plurality of access points, each access point including a first transceiver for wireless communication with one or more user workstations, and the access points including second transceivers for wireless communication with one another, wherein the access points are configured for movement to enable reconfiguration of the local area network, and wherein the local area network further comprises a track arrangement along which the access points can be moved.

14. A local area network comprising a plurality of access points, each access point including a first transceiver for wireless communication with one or more user workstations, and the access points including second transceivers for wireless communication with one another, wherein the access points are configured for movement to enable reconfiguration of the local area network, wherein each access point includes a buoyancy device, the buoyancy devices being such that, in use, the access points can be positioned so as to float at predetermined heights, and wherein each access point includes a drive for moving that access point to enable reconfiguration of the local area network, each of the buoyancy devices including a helium balloon, each of the helium balloons being such that its buoyancy substantially matches the combined mass of the associated access point and drive, and the drive of each access point including an electric motor and propeller.

15. A local area network comprising a plurality of access points, each access point including a first transceiver for wireless communication with one or more user workstations, and the access points including second transceivers for wireless communication with one another, wherein the access points are configured for movement to enable reconfiguration of the local area network, wherein each access point includes a drive for moving that access point to enable reconfiguration of the local area network, and wherein the local area network further comprises a track arrangement along which the access points can be moved, each access point including a support wheel engageable with the track arrangement.

16. An access point for a local area network comprising a first transceiver for wireless communication with one or more user workstations, a second transceiver for wireless communication with other access points, wherein the access points is configured for movement to enable reconfiguration of the local area network.

17. An access point as claimed in claim 16, wherein the access point includes a drive for moving that access point to enable reconfiguration of the local area network.

18. An access point as claimed in claim 17, wherein the access point includes a buoyancy device such that, in use, the access point can be positioned so as to float at predetermined heights.

19. An access point as claimed in claim 18, wherein the buoyancy device includes a helium balloon.

20. An access point as claimed in claim 19, wherein the helium balloon is such that its buoyancy substantially matches the combined mass of the associated access point and drive.

21. An access point as claimed in claim 17, the drive of each access point configured for movement includes an electric motor and propeller.

22. An access point as claimed in claim 16, wherein the access point includes a support wheel adapted to be engageable with a track arrangement along which the access points configured for movement can be moved.
